(19) United States
(12) Patent Application Publication
(10) Pub. No.: US 2004/0135911 A1
(43) Pub. Date: Jul. 15, 2004

(54) Active pixel sensor for digital imaging

(76) Inventors: Arokia Nathan, Waterloo (CA); Karim S. Karim, Kitchener (CA)

Correspondence Address: PEARNE & GORDON LLP, 1801 EAST 9TH STREET, SUITE 1200, CLEVELAND, OH, 44114-3108, US

(21) Appl. No.: 10/468,344

(22) PCT Filed: Feb. 18, 2002
(86) PCT No.: PCT/CA02/00172

(51) Int. Cl. H04N 5/335

(52) U.S. Cl. 348/308

(57) ABSTRACT

An active pixel sensor for digital imaging comprises a detector, a readout circuit, and a resistive load. The detector is integrated with the readout circuit and the readout circuit has a plurality of amorphous silicon based thin-film transistors (TFTs). The readout circuit is embedded under the detector to provide a high fill factor. A signal charge is accumulated on a pixel capacitance during an integration mode and is transferred to an external electronics for data acquisition via the readout circuit during a readout mode. An output current from the readout circuit is converted to a voltage through the resistive load. The resistive load may be a thin-film transistor operated in a saturation regime and having a width larger than a length in size. The active pixel sensor amplifies an on-pixel sensor input signal to improve a noise immunity of sensitive sensor input signals to external noise sources and its linearity together with a fast pixel readout time.

### BACKGROUND OF THE INVENTION

1. Field of the Invention

The present invention relates to digital imaging system, and more particularly to an active pixel sensor (APS) for digital imaging.

2. Description of the Prior Art

Amorphous silicon (a-Si) active matrix flat-panel imagers (AMFPIs) have gained considerable significance in digital imaging, and more recently in diagnostic medical imaging applications, in view of their large area readout capability. The pixel, forming the fundamental unit of the active matrix, consists of a detector and readout circuit to efficiently transfer the collected electrons to external electronics for data acquisition. The pixel architecture most commonly used is the passive pixel sensor (PPS) where a detector (e.g. amorphous selenium (a-Se) based photoconductor or CsI phosphor coupled to an a-Si:H p-i-n photodiode) is integrated with a readout circuit comprising a thin-film transistor (TFT) switch. Signal charge is accumulated on the pixel capacitance (which is either the p-i-n photodiode capacitance or an integrated storage capacitor for the a-Se photoconductor arrangement) during the integration period and is transferred to an external charge amplifier via the TFT switch during readout.

While the PPS has the advantage of being compact and thus amenable to high-resolution imaging (e.g. mammography), reading the small output signal of the PPS for low input, large area applications (e.g. fluoroscopy) requires high performance charge amplifiers. More importantly, these charge amplifiers introduce noise that degrades the signal-to-noise ratio (SNR) at low signal levels. A current-mediated a-Si TFT APS readout circuit was previously reported that incorporated on-pixel signal amplification for improved SNR in digital fluoroscopy. A voltage-mediated a-Si TFT APS (V-APS) readout circuit is employed to eliminate the need for external amplifiers in digital mammography or radiography applications.

### SUMMARY OF THE INVENTION

Accordingly, it is an object of the present invention to provide an active pixel sensor (APS) for digital imaging, capable of amplifying an on-pixel sensor input signal to improve a noise immunity of sensitive sensor input signals to external noise sources and its linearity together with a fast pixel readout time.

In order to achieve the above object, an active pixel sensor according to the present invention comprises a detector for generating photo-carriers discharging a certain level of induced voltage with an input signal; a readout circuit for outputting a current with respect to the induced voltage; and a resistive load for converting the output current to a voltage.

Preferably, the detector is either an amorphous selenium (a-Se) based photoconductor or a CsI phosphor coupled to an a-Si:H p-i-n photodiode.

Further, the readout circuit has a plurality of amorphous silicon based thin-film transistors, the plurality of thin-film transistors is three thin-film transistors and one of which is formed in a source follower circuit for producing an output current, the readout circuit is embedded under the detector to provide a high fill factor. The readout circuit is a current-mediated a-Si thin-film transistor readout circuit or a voltage-mediated a-Si thin-film transistor readout circuit. The readout circuit produces the output current through a reset, integration and readout mode operation sequence.

Furthermore, the resistive load may be an integrated n+ a-Si film resistor, the resistance of the resistor may be 1.3 GΩ or 500MΩ. The resistive load may also be a thin-film transistor. The thin-film transistor is operated in a saturation regime, and the thin-film transistor has a width thereof larger than a length thereof in size.

The active pixel sensor for digital imaging amplifies an on-pixel sensor input signal to improve a noise immunity of sensitive input signals to external noise sources and its linearity together with a fast pixel readout time.

### BRIEF DESCRIPTION OF THE DRAWINGS

The above object and other features of the present invention will become more apparent by describing a preferred embodiments thereof with reference to the attached drawings, in which:

FIG. 1 shows an amorphous silicon-voltage mediated active pixel sensor (V-APS);

FIG. 2 and FIG. 2A show an amorphous silicon voltage mediated active pixel sensor according to an implementation of the present invention and a graph of measurements of APS large signal linearity and dynamic range, respectively;

FIG. 3 and FIGS. 3A to 3C show an active Pixel sensor of FIG. 2 and graphs of measurements of rise and fall times at different frequencies; and

FIG. 4 shows a graph of stability of an n⁺ a-Si film resistor for different bias voltages.

FIG. 5 shows a current mode active pixel schematic;

FIG. 6 shows a circuit for linearity test setup with small signal output voltage as a function of input voltage;

FIGS. 7 and 8 shows gain test setup with measured voltage gain and theoretical charge gain results based on different values of C_{PIX};

FIG. 9 is a virtual earth charge integrator configuration;

FIGS. 10 and 11 are APS during readout circuit and small signal equivalent with noise sources;

FIGS. 12 and 13 DC gain of the APS circuit and small signal equivalent circuit;

FIG. 14 shows positive and negative bias induced shift; and

FIG. 15 shows pulse bias induced V_{T} shift using a +20 V/−20 V 50% duty cycle pulse.

### DETAILED DESCRIPTION OF THE PREFERRED IMPLEMENTATION

Unlike a conventional PPS, which has only one TFT switch, there are three TFTs in the APS pixel. This could undermine fill factor if conventional methods of placing the sensor and TFTs are used. Therefore, in an effort to optimize fill factor, the TFTs are assumed to be embedded under the sensor to provide high fill factor imaging systems, which follows from the continuous layer sensor architecture concept suggested previously.

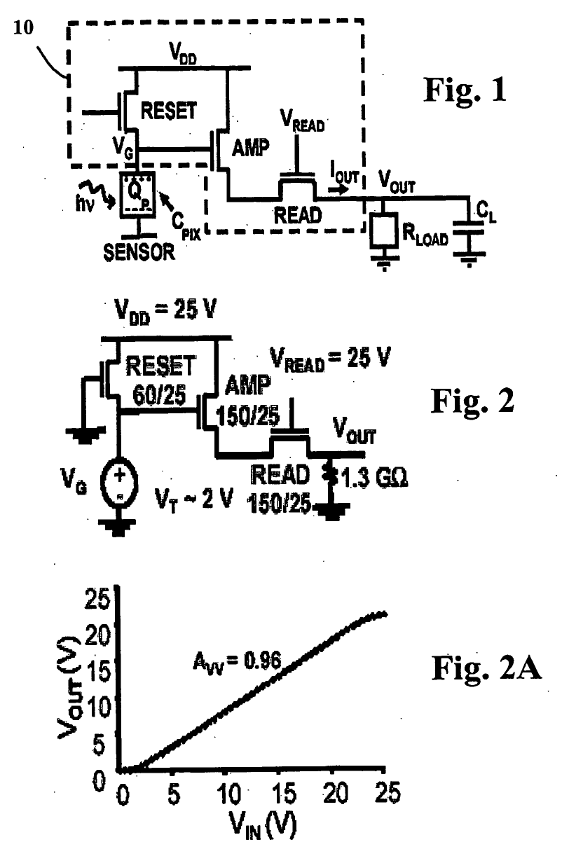

Central to the V-APS is a source follower circuit, which produces an output current that is converted to a voltage by a resistive load. The V-APS circuit is popular in CMOS imaging and is illustrated in FIG. 1. The V-APS operates in three modes: (1) Reset: The RESET TFT is switched ON and the pixel capacitance, C_{PIX} charges up to Qₚ through this TFT's ON resistance, R_{ON}_{_{—}}_{RESET}. (2) Integration: After reset, the RESET TFT is switched OFF for an integration period, T_{INT}. During T_{INT}, the x-ray input signal, hν, generates photo-carriers discharging C_{PIX} by ΔQ_{P} decreasing V_{G}. (3) Readout: After integration, the READ TFT is switched ON for a sampling time T_{S} where a load resistance converts the output current into a voltage.

In the APS pixel circuit, the characteristic threshold voltage (V_{T}) shift of the a-Si TFTs is not an issue since the TFTs have a duty cycle of less than 0.1%, which is typical of most large area applications. In addition, operating the READ and RESET TFTs as switches reduces interpixel V_{T} non-uniformities. Although the saturated AMP TFT suffers from process non-uniformity related fixed pattern noise (FPN), double sampling can alleviate the problem.

Referring to FIG. 1, the large signal expression in Eq. (1) relates a intermediate node voltage, V_{B}, of the V-APS readout circuit 10 to the input, V_{G}. Here, the drain current of the saturated AMP TFT during V-APS readout has been set equal to the current through R_{D}, the sum of the READ switch ON resistance, R_{ON}_{_{—}}_{READ} (approximated as a constant) and R_{LOAD},

$${V}_{B} = \frac{{K}_{AMP}}{2} {( {V}_{G} - {V}_{B} - {V}_{T} )}^{2} {R}_{D} \qquad ( 1 )$$

where K_{AMP} denotes the usual product of parameters, (μFETC_{G}W/L). Solving Eq. (1) and differentiating V_{B} with respect to V_{G} yields,

$$\frac{Δ {V}_{OUT}}{Δ {V}_{B}} = 1 - \frac{1}{{( 1 + 2 {K}_{AMP} {R}_{D} ( {V}_{G} - {V}_{T} ) )}^{1 / 2}} \qquad ( 2 )$$

From eqn. (2), the large signal voltage gain of the AMP TFT source follower approaches unity for a large (K_{AMP}R_{D}) product and V_{G}>V_{T}. In addition, since a constant value for eqn. (2) implies linearity, a large (K_{AMP}R_{D}) product also minimizes gain variations for different values of V_{G}. Lastly, the voltage divider formed by R_{ON}_{_{—}}_{READ} and R_{LOAD}, causes an additional linear drop in gain so the overall V-APS voltage gain, A_{VV} becomes equation (3) as below. That is,

$${A}_{VV} = \frac{Δ {V}_{OUT}}{Δ {V}_{B}} \cdot \frac{Δ {V}_{B}}{Δ {V}_{G}} = \frac{Δ {V}_{OUT}}{Δ {V}_{G}} \approx \frac{{R}_{LOAD}}{{R}_{LOAD} + {R}_{ON\_READ}} ( 1 - \frac{1}{{( 1 + 2 {K}_{AMP} {R}_{D} ( {V}_{G} - {V}_{T} ) )}^{1 / 2}} )$$

In general, R_{LOAD} is designed to be much larger than R_{ON}_{_{—}}_{READ} so the drop in gain is minimal.

Large, area medical imaging applications such as mammography have been reported to require imaging arrays with 3600×4800 pixels and a maximum readout time of 2-5 seconds per frame. The readout time requirement arises from the sensor's dark current degrading the integrated signal charge stored on each pixel's C_{PIX} over time. The lower currents and larger resistances (in MΩ) of a-Si TFTs as well as the large column bus capacitances in large area arrays make V-APS readout relatively slow. The large readout time for a frame required for an a-Si V-APS pixel can make it comparable to the dark current limited maximum frame readout time. Hence, the V-APS must be designed to meet the frame readout requirement. The column bus capacitance (C_{L}) comprises primarily of the sum of the gate to source capacitances (C_{GS}) of the READ TFTS in all of the APS pixels connected to a particular column. C_{L} usually ranges from 10 pF to 100 pF for typical large area imaging arrays.

Referring to FIG. 1, the V-APS circuit can have a load that is either an integrated n+ a-Si film resistor (R_{LOAD}) or a TFT. The load TFT (LD TFT), with a gate bias of V_{LOAD}, is operated in the saturation regime (i.e. V_{OUT}≧V_{LOAD}−V_{T}) since its channel resistance, R_{LD(sat)}, stays relatively constant and is insensitive to any variations in V_{OUT}. A V_{OUT} insensitive load is necessary for linearity as shown by the constant R_{D} in eqn. (2). The channel resistance of a TFT operated in the linear region R_{LD(lin)}, is dependent on V_{OUT} which, using eqn. (2), implies nonlinear V-APS operation.

The V-APS readout time consists of a rise and fall time component. To estimate the VAPS rise time, tᵣᵢₛₑ, KCL equations at node B and V_{OUT} yield a second order differential equation that is easier to solve numerically via a circuit simulator. However, some insight into the circuit may be gained if the READ TFT is neglected from the analysis altogether. Neglecting the READ TFT and using an LD TFT as the load, the sum of currents at the V_{OUT} node yields,

$${{K}_{AMP}^{′} ( {V}_{G} - {V}_{OUT} - {V}_{T} )}^{2} = {I}_{LD} + {C}_{L} \frac{ⅆ {V}_{OUT}}{ⅆ t} \qquad ( 4 )$$

where K′_{AMP}=(μ_{FET}C_{G}W/2L) and I_{LD} is the current in the LD TFT. Eqn. (4) is a first order ordinary differential equation that can be rewritten as,

$$\int ⅆ t = \int \frac{{C}_{L}}{⌊ {{K}_{AMP}^{′} ( {V}_{G} - {V}_{OUT} - {V}_{T} )}^{2} - {I}_{LD} ⌋} ⅆ {V}_{OUT} \qquad ( 5 )$$

The solution to eqn. (5) is of the form,

$${t}_{rise} = \frac{{C}_{L}}{\sqrt{{K}_{AMP}^{′} {I}_{LD}}} {tanh}^{- 1} [ \frac{( \sqrt{{K}_{AMP}^{′}} ( {V}_{G} - {V}_{OUT} {V}_{T} ) )}{\sqrt{{I}_{LD}}} ] + K \qquad ( 6 )$$

where K is an integration constant. While circuit simulation software (e.g. Spectre, Hspice) give results to a desired accuracy, eqn. (6) illustrates how C_{L}, K_{AMP} and I_{LD} relate to tᵣᵢₛₑ. For a fast tᵣᵢₛₑ, C_{L} should be minimized, I_{LD} should be maximized and there exists some optimum K′_{AMP} that can be determined from simulation. Reducing the size of the READ TFT in each APS pixel decreases C_{GS} and minimizes C_{L}. I_{LD} is made larger by choosing either a larger V_{LOAD} or a larger W/L for the LD TFT. As reported previously, increasing V_{LOAD} decreases dynamic range by increasing the minimum valid V_{OUT} voltage level of the V-APS since the LD TFT now enters the linear region at a larger value of V_{OUT}. Thus, increasing the size (WIL) of the LD TFT W is a preferable alternative in achieving a lower tᵣᵢₛₑ.

While increasing the current through the LD TFT, I_{LD}, reduces tᵣᵢₛₑ, it also has the adverse effect of reducing the largest achievable V_{OUT} voltage level and hence, the dynamic range. The maximum achievable V_{OUT} due to increased I_{LD} can be estimated by noting that when V_{OUT(MAX)} settles at equilibrium, the current through the AMP TFT, I_{AMP} must be equal to I_{LD}. Equating I_{AMP(sat)} to I_{LD(sat)}, and assuming both TFTs are in saturation,

K_{AMP}(V_{G}−V_{B(MAX)}−V_{T})²=K_{LD}(V_{LOAD}−V_{T})² (7)

Solving eqn. (7) for the intermediate node voltage, V_{B(MAX)} gives,

$${V}_{B ( MAX )} = {V}_{G} - {V}_{T} - \sqrt{\frac{{K}_{LD}}{{K}_{AMP}} ( {V}_{LOAD} - {V}_{T} )} \qquad ( 8 )$$

And V_{OUT(MAX)} is V_{B(MAX)} reduced by the voltage divider formed witfh R_{ON}_{_{—}}_{READ} and R_{LD(sat)},

$${V}_{OUT ( MAX )} = {V}_{B ( MAX )} [ \frac{{R}_{LD ( sat )}}{{R}_{LD ( sat )} + {R}_{ON\_READ}} ] \qquad ( 9 )$$

Also, in addition to reducing the dynamic range, a larger I_{LD(sat)} gives a smaller R_{LD(sat)}, where R_{LD(sat)} is the usual (λI_{LD(sat)})⁻¹ and λ is the channel length modulation parameter. Using eqn. (3) with R_{LOAD}=R_{LD(sat)}, it can be seen that a large I_{LD} reduces the linearity and gain of the V-APS.

So it can be concluded that in designing for a small tᵣᵢₛₑ, a tradeoff between readout speed, dynamic range, linearity and gain exists. The tᵣᵢₛₑ for an n⁺ a-Si film resistor with R_{LOAD} in place of the LD TFT is similar to the tᵣᵢₛₑ with a LD TFT. A smaller R_{LOAD} gives a faster rise time but trades off dynamic range, linearity and gain.

For the V-APS fall time, t_{fall}, the situation is considerably simpler since the READ TFT is OFF. If a LD TFT is used, it initially behaves as a constant current source discharging V_{OUT} until it enters the linear region of operation where it approximates the discharging of a single RC time constant circuit. Thus, t_{fall} of a V-APS with a LOAD TFT can be written as,

$${t}_{fall} = \frac{( {V}_{OUT} - {V}_{LOAD} - {V}_{T} ) \cdot {C}_{L}}{{I}_{LD ( sat )}} + {mR}_{LD ( lin )} {C}_{L} \qquad ( 10 )$$

where m is the number of time constants (typically five) required for complete readout, R_{LD(lin)} is the average ON resistance of the LD TFT in the linear region and I_{LD(sat)} is the LD TFT saturation current. For the n⁺ a-Si film resistor, R_{LOAD}, t_{fall} is given by a single RC time constant,

t_{fall}=mR_{LOAD}C_{L} (11)

Depending on the value of R_{LOAD} or R_{LD(lin)}, t_{fall} can be several times larger than tᵣᵢₛₑ. However, dynamic range may be traded for an increase in the frequency of V-APS operation by preventing the circuit from discharging completely. This idea will be briefly discussed in the next section.

FIG. 2 shows an exemplary V-APS pixel, consisting of an integrated a-Si amplifier circuit in a 250×250 μm² pixel area with a 1.3 GΩ n⁺ a-Si film load resistor. Large signal linearity measurements of the V-APS are shown in FIG. 2A where the large R_{LOAD} gives an almost ideal gain, A_{VV}=0.96 in the linear region of the curve. Here, Keithley Model 236 SMUs are used to supply and measure the input and output voltages, respectively.

The measured data matches simulations using a previously developed a-Si TFT model to within 5%. In FIG. 2, V_{OUT} levels off at lower voltages (around V_{T}) due to the AMP TFT not turning on. At higher voltages, V_{OUT} levels off as given in eqn. (9).

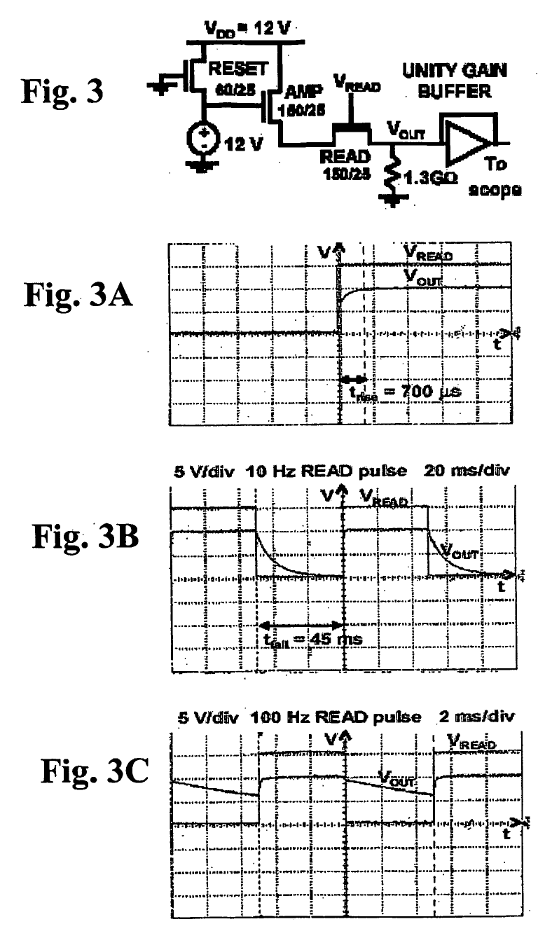

The V-APS readout time are shown in FIGS. 3A-3C. Here, a Burr-Brown instrumentation amplifier INA116 was connected in a unity gain configuration at the V-APS output node to facilitate measurement of V_{OUT} (see FIG. 3). The unity gain opamp buffer minimized the loading effect of the 1.3 GΩ resistor on the oscilloscope input probe, which was essential for accurate measurement of V_{OUT}. The load capacitance, C_{L}, was supplied by the INA116's input capacitance of 7 pF. Initially, the READ pulse was operated at 10 Hz (100 ms period) (FIGS. 3A and 3B) to allow for complete rise and fall times. From FIGS. 3A-3C, it can be seen that tᵣᵢₛₑ ˜700 us while t_{fall} ˜50 ms.

Both measurements agree with simulations to within 5%. In addition, t_{fall} can be estimated from eqn. (11) as being 45.5 ms. Lastly, a readout time measurement for a READ pulse of 100 Hz is presented in FIG. 3C. As illustrated, speeding up the readout operation causes a reduction in dynamic range since VOUT does not discharge completely between READ cycles.

The main benefit of using an n⁺ a-Si film resistor over an a-Si LD TFT is its relative immunity to metastability. For the TFT, a continuous V_{LOAD} bias at the gate causes a time dependent shift in the threshold voltage, which serves to reduce the dynamic range (by increasing the minimum valid V_{OUT} level) as well as increasing readout time (by decreasing I_{LD}).

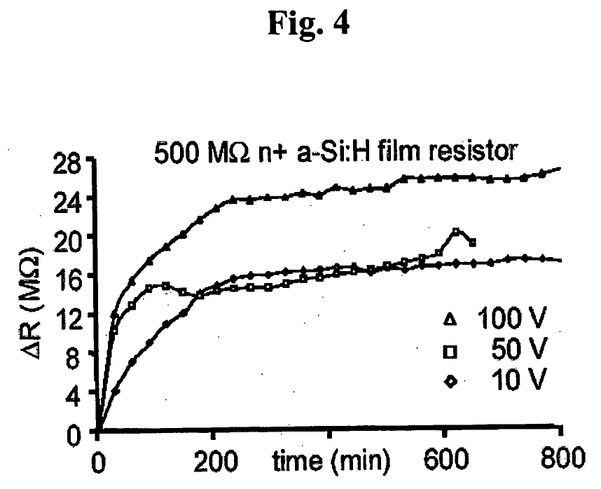

In contrast, initial stress tests conducted on a 500 MΩ n⁺ a-Si film resistor (see FIG. 4) for different biases revealed a maximum change in resistance of 6% over 15 hours. These results indicate better stability than a-Si TFTs where the threshold voltage change was measured to be as much as 20% over a similar time period. The primary advantage of using an a-Si LD TFT in place of a resistor is attaining fast readout times without sacrificing linearity or gain. During readout, the AMP TFT behaves as a voltage dependent current source charging up C_{L}, while the LD TFT provides an opposing (and smaller) constant current source discharging C_{L}. The worst case for the charging process, i.e. to V_{OUT(MAX)}, can by symbolically represented as,

$${t}_{rise} = \frac{{V}_{OUT ( MAX )} {C}_{L}}{( {I}_{AMP} ( {V}_{OUT} ( t ) ) - {I}_{LD} )} \qquad ( 12 )$$

where I_{AMP} is the V_{OUT} dependent charging current through the AMP TFT. From eqn. (12), reducing V_{OUT(MAX)} and hence the dynamic range reduces the rise time, tᵣᵢₛₑ. Referring to eqn. (8), choosing the appropriate LD TFT to AMP TFT aspect ratio gives a corresponding decrease in V_{OUT(MAX)} while reducing V_{LOAD} maintains a low value for I_{LD}. As noted previously, since R_{LD(sat)}=(λI_{LD(sat)})⁻¹, keeping a low I_{LD(sat)} provides a large R_{LD(sat)}, hence preserving gain and linearity (see eqn. (3)). In contrast, decreasing the resistance of the n⁺ a-Si film decreases tᵣᵢₛₑ due to a reduced dynamic range but gain and linearity are not preserved as with a saturated LD TFT.

The 100 Hz READ pulse frequency measurement in FIG. 3C illustrates another manner in which the dynamic range can be traded off for a reduction in readout time. For a typical mammographic digital imaging array, there are 3600×4800 pixels and an x-ray induced signal charge of 1.8×104 to 7.2×10⁶ electrons. Using the input charge and a nominal 1 pF pixel capacitance, the input signal voltage ranges from 3.84 mV to 1.536 V which implies that a dynamic range of 2 V is sufficient. Similarly, the acceptable dynamic range for radiography is less than 1 V. In calculations of readout time, a column parallel readout architecture (i.e. a row of pixels read out simultaneously) and V-APS loads (TFTs or resistors) on both ends of the large area array are assumed. Hence, 1800 pixel rows need to be read out simultaneously-on each side in less than 2 seconds, which allows 1.1 ms of readout time per row of pixels. (1 kHz V-APS operation). Following the design procedure highlighted in the previous section, a 1 ms readout time per pixel row is achievable with current state-of-the-art a-Si technology.

The primary advantage of the V-APS circuit over traditional PPS circuits is that external amplifiers are not required to obtain a readable output voltage, which reduces the array component count and cost. However, the reduction in gain in achieving real time readout (30 kHz pixel operation) of the V-APS circuit makes it suitable for higher input signals such as static chest radiography or mammography applications. Noise added by the 1 GΩ resistor is not a concern because, for a 1 kHz bandwidth3, an R_{LOAD} of 1 GΩ adds a (4kTBR_{LOAD})^{1/2} thermal noise variance which yields a readout resolution of 129 μV. Lastly, the V-APS architecture is suitable for direct connection to an integrated multiplexer, which has the potential to reduce external bond pad connections.

Disclosed is an a-Si TFT on-pixel V-APS readout circuit that provides in-situ voltage amplification and hence eliminates the need for an external amplifier. Measurements show excellent linearity, dynamic range, and near unity gain. Lastly, the readout time can be designed to meet the operating frequency requirements for large area mammographic or radiographic imagers by trading off some of the dynamic range.

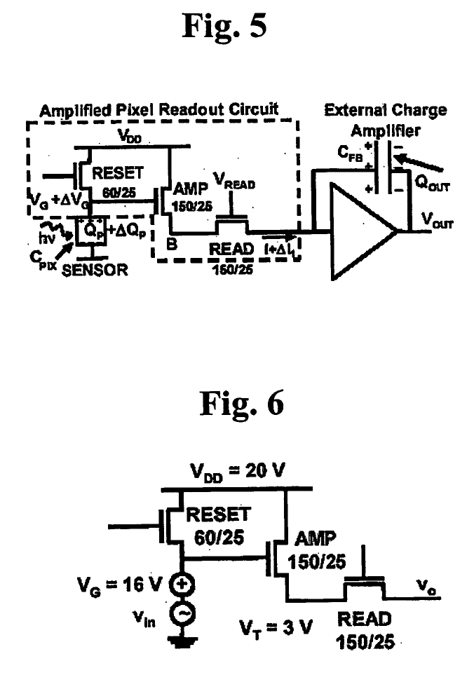

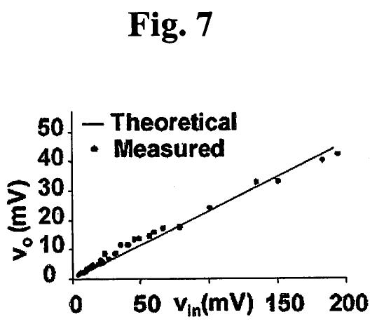

In another aspect, central to the APS illustrated in FIG. 5 is a source follower circuit, which produces a current output (C-APS) to drive an external charge amplifier.

The a-Si C-APS operates in three modes: —Reset mode: The RESET TFT switch is pulsed ON and CPIX charges up to Q_{P} through the TFT's on resistance. CPIX is usually dominated by the detector (e.g. a-Se photoconductor or a-Si photodiode detection layer) capacitance: —Integration mode: After reset, the RESET and READ TFT switches are turned OFF. During the integration period, TINT, the input signal, hν, generates photocarriers discharging CPIX by □QP and decreases the potential on CPIX by ΔVG; and —Readout mode: After integration, the READ TFT switch is turned ON for a sampling time TS, which connects the APS pixel to the charge amplifier and an output voltage, VOUT, is developed across CFB proportional to TS.

In the C-APS circuit, the characteristic threshold voltage shift of a-Si. TFTs is manageable since the TFTs have a duty cycle of ˜0.1% in typical large area applications. Therefore, appropriate biasing voltages in the TFT ON and OFF states can minimize the threshold voltage shift. Operating the READ and RESET TFTs in the linear region reduces the effect of inter-pixel threshold voltage (VT) non-uniformities.

However, although the saturated AMP TFT causes the C-APS to suffer from FPN, using CMOS-like off-chip double sampling techniques can-alleviate the problem.

The linearity of the C-APS architecture is obtained from a sensitivity analysis of the change in output current, ΔI_{OUT}, with respect to the input illumination, hν in FIG. 5,

$$\begin{matrix}γ = \frac{ⅆ [ log \vert Δ {I}_{OUT} \vert ]}{ⅆ [ log \vert hv \vert ]} \\ = \frac{ⅆ [ log \vert Δ {Q}_{P} \vert ]}{ⅆ [ log \vert hv \vert ]} \cdot \frac{ⅆ [ log \vert Δ {V}_{G} \vert ]}{ⅆ [ log \vert Δ {Q}_{P} \vert ]} \cdot \frac{ⅆ [ log \vert Δ {I}_{OUT} \vert ]}{ⅆ [ log \vert Δ {V}_{G} \vert ]} ,\end{matrix} \qquad [ 1 ]$$

where γ=1 for an ideal linear sensor, ΔVG is the change in the gate voltage of the AMP TFT due to ΔQ_{P}. The first term is linear if the detector gives a linear change in the charge on CPIX, ΔQ_{P} with changing hν. The second term depends upon the voltage change ΔV_{G} across CPIX with changing ΔQP where,

ΔQ_{P}=ΔV_{G}.CPIX, [2]

The second term is linear provided CPIX stays constant under the changing bias conditions. The last term imposes a linear small signal condition on the AMP TFT gate input ΔVG,

ΔV_{G}<<2(V_{G}−V_{T}) [3]

where V_{G} is the DC bias voltage at the AMP TFT gate and V_{T} is its threshold voltage.

When photons are incident on the detector, electron-hole pairs are created leading to a change in the charge given by eqn. [2]. In small signal operation, the change in the amplifier's output current with respect to a small change in gate voltage, ΔVG is,

ΔI_{OUT}=gm.ΔV_{G}=gm.vin [4]

where gm is the transconductance of the AMP and READ TFT composite circuit [12] and vin represents the small signal voltage at the gate of the AMP TFT. Using eqn. [2] and eqn. [4], the charge gain, Gi, stemming from the drain current modulation is:

Gi=|ΔQ_{OUT}/ΔQ_{P}|=(ΔI_{OUT}.T_{S})/ΔQ_{P}=(gm.T_{S})/CPIX. [5]

The charge gain amplifies the input signal making it resilient to external noise sources.

Linearity

The C-APS test pixel, consisting of an integrated a-Si amplifier circuit in a 250×250 □m2 pixel area, was fabricated in-house and is shown in FIG. 5. Based on the test setup and data in FIG. 6, the small signal linearity is within 5% of the theoretical value.

Gain

Gain measurements were performed on a C-APS test circuit using the charge amplifer of FIG. 5, the test circuit shown in FIG. 6, CFB=10 pF and varying the READ pulse width, TS. A commercially available charge amplifier, Burr-Brown IVC102P was used with a DC bias of VG=16 V at the gate of the AMP TFT. Using eqn. [4] and assuming constant ΔI_{OUT}, ΔV_{OUT} for the charge integrating circuit in FIG. 5 can be written as,

$$\begin{matrix}Δ {V}_{OUT} = - \frac{1}{{C}_{FB}} {\int }_{0}^{{T}_{S}} Δ {I}_{OUT} ⅆ t \\ = \frac{Δ {I}_{OUT} {T}_{S}}{{C}_{FB}} \\ = \frac{( {g}_{m} Δ {V}_{G} ) {T}_{S}}{{C}_{FB}} \\ = \frac{( {g}_{m} {v}_{i n} ) {T}_{S}}{{C}_{FB}} .\end{matrix} \qquad [ 6 ]$$

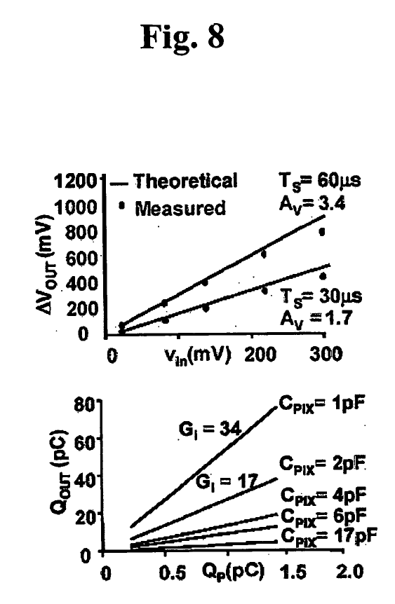

Theoretical voltage gain, AV (based on eqn. [6] where AV=ΔV_{OUT}/vin) and experimental results in FIG. 8 agree reasonably well with a maximum discrepancy of about 20%. Using eqn. [5] and eqn. [6], it can be shown that,

Gi=|ΔQ_{OUT}/ΔQ_{P}|=AV.(C_{FB}/C_{PIX}). [7].

The verified theoretical, model of eqn. [6] was extended to predict charge gain using eqn. [7] for different values of CPIX and TS=60 □s in FIG. 8

Theoretically, using a low capacitance sensor (i.e. small CPIX) provides a higher charge gain, which minimizes the effect of external noise. However, a tradeoff between pixel gain and amplifier saturation places an upper limit on the achievable charge gain. In addition, minimizing CPIX will also reduce the reset time constant (which comprises mainly of the RESET TFT on-resistance and CPIX), hence reducing image lag. For example, assuming column parallel readout, a typical array comprising of 1000×1000 pixels operating in real-time at 30 frames/sec allows 33 μs for each pixel's readout and reset. Typical values for a-Si RESET TFT on resistance (˜1 MΩ) and CPIX (˜1 pF for a-Se) yield an RC time constant of 1 μs implying 5 μs resets would eliminate image lag and still allow sufficient time for readout with double sampling. Like other current, mode circuits, the C-APS, operating at 30 kHz, is susceptible to sampling-clock jitter. However, off-chip low-jitter clocks using crystal oscillators can alleviate this problem.

Eqn. [7] shows that the C-APS has two inter-related sources of voltage gain i.e. the charge gain, Gi and the ratio of two capacitors, CPIX and CFB. However, the voltage gain is independent of CPIX and depends on the size of CFB where a larger AVC can be obtained by using a smaller CFB. A substantial increase in charge gain can be achieved by a judicious choice of gm where gm depends on both the AMP and READ TFTs. To illustrate this, note that IOUT is the biasing drain current in both transistors and assuming the READ TFT is operating in the ohmic region with a constant resistance, RON_READ,

$$\begin{matrix}{I}_{OUT} = \frac{\begin{matrix}1 + 2 {R}_{ON\_READ} {K}_{AMP} ( {V}_{G} - {V}_{T} ) - \\ \sqrt{1 + 4 {R}_{ON\_READ} {K}_{AMP} ( {V}_{G} - {V}_{T} )}\end{matrix}}{2 {R}_{ON\_READ}^{2} {K}_{AMP}} , & [ 8 ] \\ \begin{matrix}{g}_{m} = \frac{\partial {I}_{OUT}}{\partial {V}_{G}} \\ = \frac{1}{{R}_{ON\_READ}} [ 1 - \frac{1}{\sqrt{1 + 4 {R}_{ON\_READ} {K}_{AMP} ( {V}_{G} - {V}_{T} )}} ] .\end{matrix} & [ 9 ]\end{matrix}$$

Based on the above two equations, R_{ON}_{_{—}}_{READ} must be minimized and K_{AMP} (V_{G}-V_{T}) must be maximized to achieve high gm. However, IOUT is inversely proportional to the R_{ON}_{_{—}}_{READ}² and hence I_{OUT} increases more than gm for a corresponding decrease in R_{ON}_{_{—}}_{READ}. Hence, using a single APS cell connected directly to a charge amplifier can cause the amplifier to saturate at high VG bias values limiting the achievable gm.

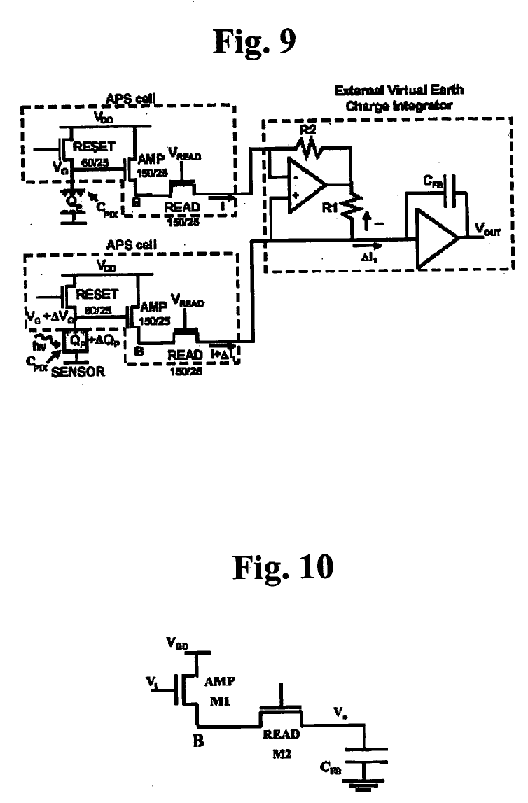

The virtual earth charge integrator (VECI) configuration shown in FIG. 9 subtracts the drain currents of two APS cells permitting only ΔI_{OUT} to reach the charge amplifier thus enabling larger gm values to be obtained. The VECI circuit is highly dependent on the matching accuracy of resistors R1 and R2 and the increased number of components can cause both noise and area to increase. Hence, the APS application determines whether a VECI configuration for higher gain or direct connection for lower noise is preferable.

Noise

The C-APS architecture is decoupled from the amplifier with a two-stage readout sequence in order to combat noise. In the first readout stage where charge amplification occurs, there are three main steady state sources of noise: thermal, flicker, and reset. Following the first stage, it is the amplified charge stored on CFB that has to face the large charge amplifier noise of the second stage.

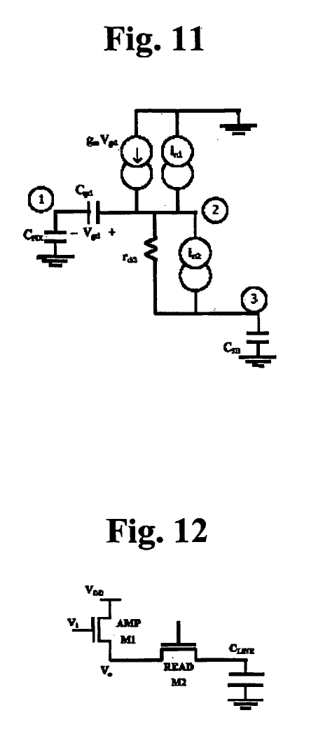

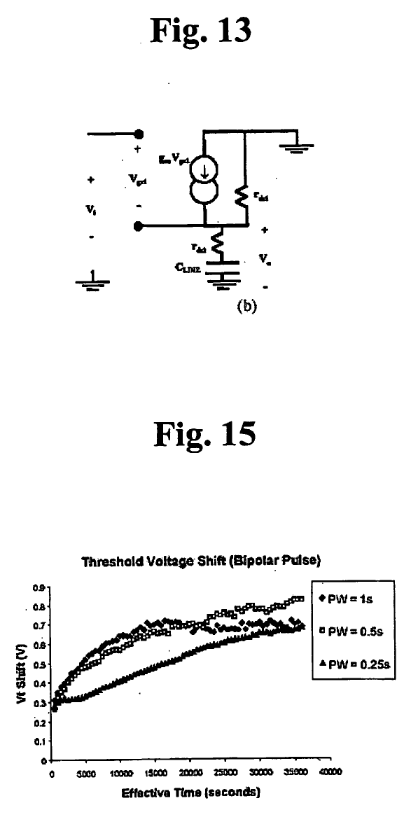

Thermal and Flicker noise. During readout, the circuit of FIG. 5 reduces to a wideband multistage amplifier configuration: i.e. a common drain stage driving a common gate stage as shown in FIG. 10. Modifying the small signal model to include independent noise sources, the equivalent circuit is shown in FIG. 11. Here, a switch resistance represents the common gate stage. The noise is sampled on the charge amplifier feedback capacitance, CFB (note that CFB indicates the effective Miller capacitance of the charge amplifier seen by the APS readout circuit). CPIX is redefined as the sum of the capacitances between the detector node and ground (˜CPD+Cgd1) and Cgs1 is the gate-source parasitic capacitance of the AMP TFT. In the steady state, the AMP TFT operates in saturation while the READ TFT operates in the linear mode. Hence, the READ TFT switch is represented by its ON resistance r_{ds2}=(1/g_{ds2}). The TFT switch ON resistance may be obtained from: RON=[K(VG−VT)]−1. in1 represents the noise from the AMP TFT while in2 represents the noise from the READ TFT.

A nodal analysis in the frequency domain (s=jω) of the equivalent circuit of FIG. 11 yields the following matrix:

$$[ \begin{matrix}s ( {C}_{PIX} + {C}_{gs1} ) & - {sC}_{gs1} & 0 \\ - {g}_{m1} - {sC}_{gs1} & {g}_{m1} + {sC}_{gs1} + {g}_{ds2} & - {g}_{ds2} \\ 0 & - {g}_{ds2} & {g}_{ds2} + {sC}_{FB}\end{matrix} ] \\ [ \begin{matrix}{V}_{1} \\ {V}_{2} \\ {V}_{3}\end{matrix} ] = [ \begin{matrix}0 \\ {i}_{n1} - {i}_{n2} \\ {i}_{n2}\end{matrix} ] . \qquad [ 10 ]$$

Solving for the noise at the output, V3 yields: The above expression can be solved and simplified assuming CFB>>CPIX>>Cgs1, and that gₘ₁.C_{PIX}>>s.C_{PIX}.Cgs1 giving:

$${V}_{3} = \frac{{i}_{n1} \cdot {R}_{eq1} + {i}_{n2} \cdot {r}_{ds2}}{1 + j ( w / {w}_{eq} )} , \\ {R}_{eq1} = {[ {g}_{m1} \cdot \frac{{C}_{PIX}}{{C}_{PIX} + {C}_{gs1}} ]}^{- 1} , \\ {w}_{eq} = [ \frac{1}{{C}_{FB}} \cdot \frac{{g}_{ds2} \cdot {g}_{m1}}{{g}_{ds2} + {g}_{m1}} ] . \qquad [ 11 ]$$

Therefore, the spectral density of the noise at the output may be repressed as,

$${S}_{v3} = \frac{{S}_{i n1} \cdot {R}_{eq1}^{2} + {S}_{i n2} \cdot {r}_{ds2}^{2}}{1 + {( w / {w}_{eq} )}^{2}} . \qquad [ 12 ]$$

At this point it is useful to note that the APS architecture suffers from processing non-uniformities in the AMP TFT threshold voltage, VT between neighboring pixels. Using a double sampling technique similar to CMOS APS architectures can compensate for VT non-uniformities. In fact, double sampling greatly reduces the effect of VT non-uniformities as well as any DC components including low frequency flicker noise. However, the penalty paid for double sampling comes in the form of extra noise. The thermal noise components from the AMP and READ TFTs, the reset noise and the amplifier noise are all increased. Since an APS imager is impracticable without double sampling, the total noise needs to be estimated with double sampling. Using Sv3 and results from for APS noise, the output thermal noise is:

Nᵥ₃²(th)=π.f_{eq}.(R_{eql}².aₜₕ₁+r_{ds2}².aₜₕ₂), [13]

where aₜₕ₁=(2/3).4kT.gml and aₜₕ₂=4kT.gds2. Similarly, using previously derived results[16], the output flicker noise becomes:

Nᵥ₃²(fl)=2.I.(R_{eql}².a_{fl1}+r_{ds2}².a_{fl2}), [14]

where a_{fl1}, and a_{fl2} are flicker noise coefficients of the saturated AMP and linear READ TFTs respectively. Expressions for a-Si:H TFT flicker noise coefficients are:

$${a}_{fl1} = \frac{{α}_{sat} \cdot q \cdot {μ}_{EFF}^{2} \cdot {C}_{G} \cdot {( \frac{W}{L} )}^{2}}{2 ( W \cdot L )} \cdot {( {V}_{G} - {V}_{T} )}^{3} , \\ {a}_{fl2} = \frac{{α}_{lin} \cdot q \cdot {μ}_{EFF}^{2} \cdot {C}_{G} \cdot {( \frac{W}{L} )}^{2}}{( W \cdot L )} \cdot ( {V}_{G} - {V}_{T} ) \cdot {V}_{DS}^{2} . \qquad [ 15 ]$$

And I is an integral that accounts for the low frequency filtering effect performed by double sampling on flicker noise.

$$I ( {x}_{eq} ) = {\int }_{0}^{∞} \frac{1 - cos x}{x ( 1 + ( {x}^{2} / {x}_{eq}^{2} ) )} \cdot ⅆ x , \qquad [ 16 ]$$

where x_{eq}=2.π.f_{eq}.τ_{f} and τ_{f} is the time between the pixel output and reset value samples (see FIG. 5). For small τf, the I(xeq) function resembles a band pass filter that eliminates low-frequency and DC noise (i.e. AMP TFT VT non-uniformities). Reset Noise. The thermal noise of the RESET TFT ON resistance is low pass filtered by the pixel capacitance, CPIX and stored on CPIX during reset. Although it is possible to approximate this noise as, Nreset²=kT/C_{PIX}, it is more accurate to include the effect of the feedback AMP TFT parasitic capacitance, Cgs1. Then the effective capacitance at the detector node becomes, Ceff=CPIX+(1−Av0).Cgs1 where Av0 is the DC gain of the AMP TFT buffer. Therefore the reset noise becomes,

Nᵣₑₛₑₜ²=kT/C_{eff}. [17]

The DC gain, Av0 can be estimated from the small signal equivalent model of the AMP and READ TFTs given below. Again, the READ TFT is simply represented as a switch resistance, r_{dS2} since it is operated in the linear mode.

Writing a node equation at the source of the AMP TFT yields,

gm1.Vgs1=Vo.(gds1+gd2), Vgs1=((gds1+gd2)/gm1).Vo, [18]

where gd2=gds2//sCFB. Since Vi=Vgs1+Vo, and gd2<<gds1 due to CFB,

$$\frac{{V}_{o}}{{V}_{i}} = {A}_{vo} = \frac{{g}_{m1}}{{g}_{m1} + {g}_{ds1} + {g}_{d2}} = \frac{1}{( 1 + \frac{1}{{g}_{m1} \cdot {r}_{ds1}} )} . \qquad [ 19 ]$$

In addition, since double sampling is used, this reset noise is increased to Nᵣₑₛₑₜ²=2kT/C_{eff}.

Total output noise and input referred noise with double sampling. Since the various APS noise sources are uncorrelated, the noise on CFB after double sampling becomes:

Nout(tot)²=Nv3²(th)+Nv3²(fl)+A1²Nᵣₑₛₑₜ², [20]

where A1 is the DC voltage gain of the APS from the AMP TFT gate to CFB node.

Nout(tot)2 can be referred to the input of the APS at node A to give Ninput(tot) as well as noise equivalent electrons (NEQ) where q is the electron charge,

$${N}_{input} ( tot ) = \frac{\sqrt{{{N}_{out} ( tot )}^{2}}}{{A}_{1}} , NEQ = \frac{\sqrt{{{N}_{out} ( tot )}^{2}} \cdot {C}_{eff}}{{A}_{1} \cdot q} . \qquad [ 21 ]$$

The amplifier noise can be modeled as having a fixed noise component Namp0 in addition to an input capacitance dependent component:

Nₐₘₚ=Nₐₘₚ₀+δC_{d}. [22]

Here δ is a constant determined by the design properties of the charge amplifier (e.g. input FET noise) and Cd is the external capacitance loading the amplifier input node. This includes the parasitic capacitances on the data line such as CGS of readout TFT as well as the overlap capacitance of data and gate lines. A typical value for the amplifier noise is about 1700 electrons. Again, the presence of double sampling causes this noise variance to double.

The above theory was used to predict the noise performance of an a-Si APS circuit. Noise added by the APS architecture to the input signal indicates that intrinsic APS noise is minimized for small C_{PIX} implying the feasibility of low capacitance detectors such as a-Se photoconductors. All calculations for an a-Si TFT APS follow from CMOS APS noise theory in [16] but with characteristic a-Si TFT parameters for large area fluoroscopy, the most challenging medical imaging application. The noise results appear promising for fluoroscopy if a CPIX=1 pF or smaller is used since the minimum input signal is 1000 electrons and the noise added by the APS circuit is less than 600 electrons. It is notable also that the major noise contribution comes from reset noise.

Scalability of the APS Architecture.

Based on the theory presented in the previous sections, it may be noted that the primary effect of scaling is to reduce the pixel area (based on a fully overlapped sensor architecture) as well as to improve the gain and pixel reset time. The latter two are essential for high gain and rapid pixel operation (i.e. 30 μs readouts) (e.g. in real time low noise fluoroscopic medical imaging).

The threshold voltage (Vt) of an a-Si TFT shifts under prolonged gate bias stress, and TFTs show different threshold voltage shift behavior under positive and negative gate bias stress. This anomalous behavior is attributed to two main mechanisms (i) charge trapping and (ii) defect state creation. The charge trapping takes place due to the trap sites in the gate insulator and/or at the insulator/a-Si:H interface. The state creation is related to the breaking of the weak bonds, which increases the density of dangling bonds in the a-Si:H. Charge trapping generally dominates at higher gate bias and/or longer duration of bias stress. In contrast, increase in the defect density takes place predominantly at lower gate fields and/or shorter duration of bias stress. The threshold voltage increases with respect to the positive stress voltage as well as the stress duration.

However we observed a turn-around effect for negative bias stress. This effect was reported in, that the threshold voltage of transistor increases for a short bias stress duration and/or small negative stress voltages and decreases for a long bias stress duration and/or large negative stress voltages. This positive Vt shift at smaller negative voltage stress and/or shorter duration of bias stress is ascribed to the increased defect density states in the band gap near the conduction band by the negative gate bias. The turn-around effect can be explained by taking the hole-trapping into account which dominates at large negative voltages and/or for longer bias stress, and offsets the effect of increased defect density by lowering the threshold voltage.

The turn-around effect is reported to be due to a higher Si/N ratio in the nitride layer. A large Si/N ratio provides more trapping centers and hence the threshold voltage shifts drastically irrespective of the polarity of bias stress. In addition, the hydrogen concentration in the a-Si:H layer affects only the negative threshold voltage shift. An absence of the turn-around effect is reported at hydrogen concentrations of 4.8% and less [24]. This can be explained since a-Si:H films with larger concentrations of hydrogen have more clusters or voids. This increases the number of states near the conduction band and threshold voltage shifts positively at low negative voltage stress. A lower hydrogen concentration causes a reduction in created defect states and the threshold voltage decreases monotonically after an application of negative voltage stress.

Under pulse biases, a-Si:H TFTs exhibit different frequency dependence for positive and negative stress voltages. Vt shift due to positive pulse bias stress is almost independent of frequency of operation. For negative pulse bias stress, Vt shift decreases in magnitude with the increase in frequency of operation and vanishes above a certain frequency. This can be explained by the defect pool model. According to this model, the Fermi level in the band gap of a-Si:H is related to the concentration of the carriers accumulated. For positive pulse bias stress, electrons rapidly accumulate in the channel of a-Si:H TFTs during ‘ON’ cycles. Due to rapid electron accumulation, the density of created states remains almost constant even at high frequencies.

For negative pulse bias stress, holes accumulate in the channel during negative cycles but due to TFT ‘OFF’ state, higher frequencies will induce less carriers and consequently the Vt shift phenomenon will become less significant. In general, smaller duty cycle induces less Vt shift with respect to effective stress time because created states can relax and/or charge can detrap during the ‘OFF’ cycles. When a bipolar pulse is applied at the gate of the TFT, charge trapping during the negative cycle partially compensates the positive Vt shift during the positive cycle but this is true only when charge trapping is dominant in the negative cycle i.e. large negative voltage is applied at the gate during negative cycle. As described above, at high frequencies, it becomes more and more difficult for holes to accumulate in the channel and hence this Vt compensation (negative Vt shift) becomes less significant.

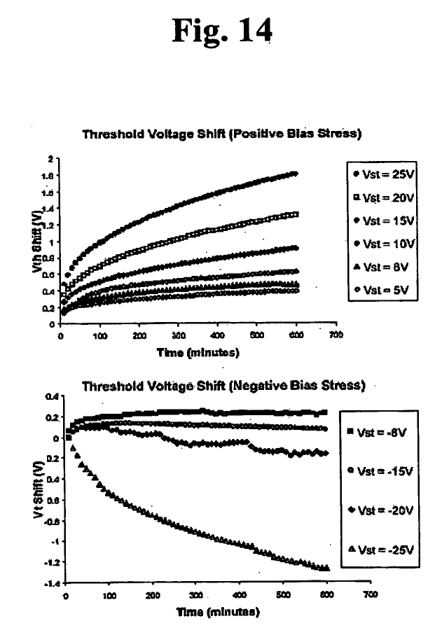

In FIG. 14, the ΔVT increases in the positive direction for positive gate bias and increases in the negative direction for high negative gate biases. FIG. 15 illustrates the stability in VT for a bipolar pulse at a frequency of 1 Hz and a 50% duty cycle. For higher clocking frequencies, stability in VT is not reached during the observed time period for the 50% duty cycle. Based on the experimental results shown, optimum positive and negative voltages for a bipolar clocking pulse that lead to a stable VT can be obtained for applications requiring lower duty cycles but higher operating frequencies

For the APS pixel, there are three TFTs of concern: READ, AMP and RESET. The main method of preserving VT stability is by choosing clocking voltages to minimize the □VT inherent in a-Si TFTs under a gate bias. For the READ and RESET switch TFTs, appropriately designed bipolar clocking pulses can be used maintain a constant VT. For the saturated AMP TFT, a positive bias of approximately VGS<VT (˜2 V) exists across the AMP TFT during the, pixel OFF state. Due to its small positive value, the 2 V bias does not aggravate the positive ΔVT. Hence, a stable VT may be obtained for the AMP TFT by using a reduced duty cycle and low positive gate biases in the ON state. In the case where larger gate biases and/or higher duty cycles are necessary, an additional bias line may be included (at the cost of pixel area) at node B (in FIG. 5) to supply a negative VT restoration voltage during the pixel OFF state. This VT control line, shown in the micrograph, is essential for large area, real time applications (e.g. 1000×1000 pixel real-time medical fluoroscopic imaging array) where typical duty cycles are <0.1% and TFTs may need to be clocked as high as 100 kHz.

It is concluded theoretically from both a signal gain and noise point of view that a low input capacitance, CPIX, is preferable. Hence, a small capacitance must be factored into the choice of an optimum detector (e.g. a-Se photoconductor). In addition, the APS must be biased to give high gm in order to achieve the greatest gain. Reset noise forms the major noise component responsible for signal degradation in the first stage of readout. The use of double sampling increases reset, thermal d charge amplifier noise but performs a low frequency filtering effect on flicker and DC noise (including any threshold voltage variations). Double sampling is essential for a practical implementation of the APS in order to remove inter pixel threshold voltage variations due to process non-uniformity. The results demonstrated here, including its scalability to state-of-the-art a-Si technology, provide the impetus to expedite development of a-Si APS arrays for low cost, fully integrated, large area, and real-time digital imaging.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

We claim:

1. An active pixel sensor for digital imaging, comprising:
a detector for generating photo-carriers discharging a certain level of induced voltage with an input signal;
a readout circuit for outputting a current with respect to the induced voltage; and
a resistive load for converting the output current to a voltage.

2. The active pixel sensor as claimed in claim 1, wherein the detector is an amorphous selenium (a-Se) based photoconductor.

3. The active pixel sensor as claimed in claim 1, wherein the detector is a CsI phosphor coupled to an a-Si:H p-i-n photodiode.

4. The active pixel sensor as claimed in claim 1, wherein the readout circuit has a plurality of amorphous silicon based thin-film transistors.

5. The active pixel sensor as claimed in claim 4, wherein the plurality of thin-film transistors is three thin-film transistors and one of which is formed in a source follower circuit for producing an output current.

6. The active pixel sensor as claimed in claim 6, wherein the readout circuit is embedded under the detector to provide a high fill factor.

7. The active pixel sensor as claimed in claim 5, wherein the readout circuit is a current-mediated a-Si thin-film transistor readout circuit.

8. The active pixel sensor as claimed in claim 1, wherein the readout circuit is a voltage-mediated a-Si thin-film transistor readout circuit.

9. The active pixel sensor as claimed in claim 4 or 8, wherein the readout circuit produces the output current through a reset, integration and readout mode operation sequence.

10. The active pixel sensor as claimed in claim 1, wherein the resistive load is an integrated n+ a-Si film resistor.

11. The active pixel sensor as claimed in claim 10, wherein the resistance of the resistor is 1.3 GΩ.

12. The active pixel sensor as claimed in claim 10, wherein the resistance of the resistor is 500MΩ.

13. The active pixel sensor as claimed in claim 1, wherein the resistive load is a thin-film transistor.

14. The active pixel sensor as claimed in claim 13, wherein the thin-film transistor is operated in a saturation regime.

15. The active pixel sensor as claimed in claim 13, wherein the thin-film transistor has a width thereof larger than a length thereof in size.
